(19) United States
(12) Patent Application Publication
(10) Pub. No.: US 2015/0166354 A1
(43) Pub. Date: Jun. 18, 2015

(54) METHOD FOR REMOVING ORGANIC CONTAMINANTS FROM BORON CONTAINING POWDERS BY HIGH TEMPERATURE PROCESSING

(71) Applicant: General Electric Company, Schenectady, NY (US)

(72) Inventors: James Michael Lustig, Mantua, OH (US); Jeffrey Louis Johanning, Hudson, OH (US)

(21) Appl. No.: 14/632,053

(22) Filed: Feb. 26, 2015

Related U.S. Application Data
(63) Continuation-in-part of application No. 13/353,379, filed on Jan. 19, 2012.

(51) Int. Cl. C01B 35/02

(52) U.S. Cl. CPC C01B 35/023

(57) ABSTRACT

A method of removing a hydrocarbon compound from boron powder for a physical intermixture. A boron powder and hydrocarbon compound physical intermixture is provided. The physical intermixture is placed onto an inert container of one of quartz or ceramic, and placing such into an enclosed space. The environment of the space is altered to create an oxygen-lessened atmosphere and then heated to an elevated temperature of between 350° C. and 600° C. The method includes vaporizing at least some the hydrocarbon compound as a physical removal of the hydrocarbon compound from the boron powder at the elevated temperature and within the oxygen-lessened atmosphere. In one example, the remaining hydrocarbon compound is not more than about 0.1 weight percent of soluble residue.

### CROSS-REFERENCE TO RELATED APPLICATION

This application is a continuation-in-part of U.S. patent application Ser. No. 13/353,379, entitled METHOD FOR REMOVING ORGANIC CONTAMINANTS FROM BORON CONTAINING POWDERS BY HIGH TEMPERATURE PROCESSING, filed Jan. 19, 2012, and which is incorporated herein by reference.

### BACKGROUND OF THE INVENTION

Boron powder is used as a primary component of boron coatings in numerous applications. Such applications include, but are not limited to boron coatings used for neutron detection, abrasion protection for die-casting dies, improved wear resistance for biomedical implants, etc. Some of these applications are adversely affected by contaminants within the boron powder, as the contaminants can be detrimental to boron coating applications.

A contaminated boron powder can include organic contaminants, in the form of at least one hydrocarbon compound, from various sources. For example, jet milled boron powder has been found to be susceptible to contamination from the air supply used in the milling process. Specifically, boron powder contaminants may include lubrication oil (e.g., a hydrocarbon compound) from an air compressor when compressed air is used to operate a jet mill. This contamination can result in coating defects such as non-uniform coatings and gas contamination resulting in degraded coating properties. Other example contaminants are polymeric liner material from the jet mill, adhesive materials used to attach the polymeric liner material to a jet mill interior wall, and metal particles from the jet mill interior wall. It is to be appreciated that the included organic contaminants, in the form of at least one hydrocarbon compound, is a physical intermixture. The boron itself (e.g., the boron powder) is chemically pure boron particles. The organic contaminants, in the form of at least one hydrocarbon compound, are not chemically integrated with the boron particles (e.g., not oxides nor other chemical compounds that include both the boron and the hydrocarbon compound).

Boron powder is a relatively expensive material which, in turn, makes both contaminated boron powder and coated goods costly missteps in the manufacturing process. Some previous methods of treating contaminated boron powder include rinsing the powder with hexane, methylene chloride, and ethylene glycol, each in combination with filters and/or centrifuges. Therefore, there is a need for an improved apparatus and method of physically removing contaminants from the surfaces of boron powder particles (i.e., removal of physically intermixed contaminants). Moreover, the process of the present invention is not a process to refine boron oxides into pure boron.

### BRIEF DESCRIPTION OF THE INVENTION

The following presents a simplified summary of the disclosed subject matter in order to provide a basic understanding of some example aspects of the disclosed subject matter. This summary is not an extensive overview of the disclosed subject matter. Moreover, this summary is not intended to identify critical elements of the invention nor delineate the scope of the disclosed subject matter. The sole purpose of the summary is to present some concepts of the invention in simplified form as a prelude to the more detailed description that is presented later.

The subject matter disclosed herein generally relates to removing physical contaminants, including at least one hydrocarbon compound, from boron powder

In accordance with one aspect, the disclosed subject matter provides a method of removing a hydrocarbon compound from boron powder for a boron powder and hydrocarbon compound physical intermixture. The method includes providing a boron powder and hydrocarbon compound physical intermixture in the form of boron powder physically intermixed with the hydrocarbon compound. The method includes placing the boron powder and hydrocarbon compound physical intermixture onto an inert container, with a material of the inert container being at least one of quartz and ceramic. The method includes placing the inert container and the boron powder and hydrocarbon compound physical intermixture into an enclosed space. The method includes altering the environment of the enclosed space to create an oxygen-lessened atmosphere within the enclosed space that has less oxygen than ambient atmosphere by one of volume number density of oxygen and by percentage of oxygen relative to other gasses. The method includes providing a heat source for the enclosed space. The method includes heating the boron powder and hydrocarbon compound physical intermixture within the oxygen-lessened atmosphere to an elevated temperature of between 350° C. and 600° C. The method includes vaporizing at least some the hydrocarbon compound as a physical removal of the hydrocarbon compound from the boron powder at the elevated temperature and within the oxygen-lessened atmosphere.

In accordance with another aspect, the disclosed subject matter provides a method of removing a hydrocarbon compound from boron powder for a boron powder and hydrocarbon compound physical intermixture. The method includes providing a boron powder and hydrocarbon compound physical intermixture in the form of boron powder physically intermixed with the hydrocarbon compound. The method includes placing the boron powder and hydrocarbon compound physical intermixture onto an inert container, with a material of the inert container being at least one of quartz and ceramic. The method includes placing the inert container and the boron powder and hydrocarbon compound physical intermixture into an enclosed space. The method includes altering the environment of the enclosed space to create an oxygen-lessened atmosphere within the enclosed space that has less oxygen than ambient atmosphere by one of volume number density of oxygen and by percentage of oxygen relative to other gasses. The method includes providing a heat source for the enclosed space. The method includes heating the boron powder and hydrocarbon compound physical intermixture within the oxygen-lessened atmosphere to an elevated temperature of between 350° C. and 600° C. The method includes vaporizing at least some the hydrocarbon compound as a physical removal of the hydrocarbon compound from the boron powder at the elevated temperature and within the oxygen-lessened atmosphere such that the amount of the hydrocarbon compound physically intermixed with the boron powder is not more than about 0.1 weight percent of soluble residue.

### BRIEF DESCRIPTION OF THE DRAWINGS

The foregoing and other aspects of the disclosed subject matter will become apparent to those skilled in the art to which the present invention relates upon reading the following description with reference to the accompanying drawings, in which:

FIG. 1 is a schematized cross section view of an example furnace of an example processing system;

FIG. 2 is a top level flow diagram of an example method of removing organic contaminants, including at least one hydrocarbon compound, from boron powder in; and

FIG. 3 is a top level flow diagram of an example method of removing organic contaminants, including at least one hydrocarbon compound, from boron powder.

### DETAILED DESCRIPTION OF THE INVENTION

Example embodiments that incorporate one or more aspects of the disclosed subject matter are described and illustrated in the drawings. These illustrated examples are not intended to be a limitation. For example, one or more aspects of the present invention can be utilized in other embodiments and even other types of devices. Moreover, certain terminology is used herein for convenience only and is not to be taken as a limitation on the disclosed subject matter. Still further, in the drawings, the same reference numerals are employed for designating the same elements.

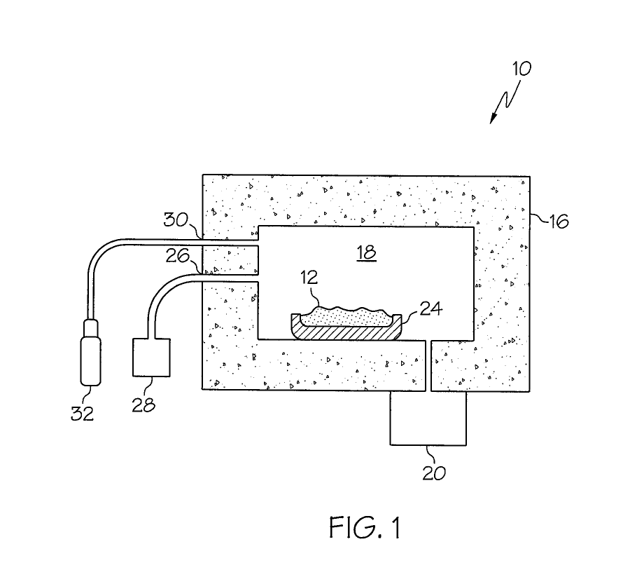

An example processing system 10 for removing contaminants from boron powder 12 is generally shown within FIG. 1. It is also to be appreciated that FIG. 1 merely shows one example of possible structures/configurations/etc. and that other examples are contemplated. In one specific example, the processing system 10 is for removing organic contaminants, in the form of at least one hydrocarbon compound, from boron powder 12. With regard to organic contaminants, in the form of at least one hydrocarbon compound, the classification includes materials that contain a carbon component. A contaminated boron powder can include organic contaminants, in the form of at least one hydrocarbon compound, from various sources. For example, jet milled boron powder has been found to be susceptible to contamination from the air supply used in the milling process. Specifically, boron powder contaminants may include lubrication oil, as an example hydrocarbon compound, from an air compressor when compressed air is used to operate a jet mill. This contamination can result in coating defects such as non-uniform coatings and gas contamination resulting in degraded coating properties. Other example contaminants are polymeric liner material from the jet mill, adhesive materials used to attach the polymeric liner material to a jet mill interior wall, and metal particles from the jet mill interior wall. It is to be appreciated that the included organic contaminants, in the form of at least one hydrocarbon compound, is a physical intermixture. The boron itself (e.g., the boron powder) is chemically pure boron particles. The organic contaminants, in the form of at least one hydrocarbon compound, are not chemically integrated with the boron particles (e.g., not oxides nor other chemical compounds that include both the boron and the hydrocarbon compound). So, at a minimum, the process of the disclosed subject matter is not a process to refine boron oxides into pure boron.

The processing system 10 for removing organic contaminants, in the form of at least one hydrocarbon compound, from contaminated boron powder 12 includes a furnace 16, which is one example of an enclosed space. Other examples of an enclosed space include, but are not limited to batch ovens, continuous ovens, cabinet ovens, tower ovens, sintering furnaces, etc. Selection of the type of furnace 16 and construction thereof is dependent upon several variables including, but not limited to, furnace heating characteristics, furnace cycle times, boron powder throughput requirements, etc. The furnace 16 includes an interior volume 18 which provides space for the contaminated boron powder 12. It is to be appreciated that the interior volume 18 of the furnace 16 can be secured so that little or no ambient atmosphere can enter into the furnace during operation of the furnace. Furthermore, the interior volume 18 can maintain a controlled atmosphere, as will be described below. The furnace 16 also includes a heat source 20 to provide an elevated temperature within the furnace 16. The heat source 20 can be any of the typical furnace or oven heat sources as are known in the art such as gas, electric heating element, infrared, microwave, etc. The heat source 20 is schematically shown and is only schematically shown in position. The structure and position can be suitably selected to heat the interior volume 18. In any of the examples, the furnace 16 can include an exhaust port that can be used to purge vaporized contaminants from the interior volume 18.

In one example of the processing system 10, the furnace 16 can include a tube oven. The tube oven can include a generally cylindrical shape wherein the axis of the cylinder is oriented substantially horizontally. The interior volume 18 of the tube oven can include various heating zones separated by operable dividers. An induction coil can be provided around the circumference of the tube oven to heat the interior volume 18 and/or the contents of the interior volume 18 according to a desired heating profile. The heating zones can include different temperatures in separate heating zones in order to subject the boron powder 12 to a desired heating profile.

The processing system 10 further includes a boat 24, which is one example of an inert container for holding the boron powder 12 within the furnace 16. The boat 24 can be made of material that is resistant to the effects of high temperature, numerous heating and cooling cycles, and is not likely to impart contaminants to the boron powder 12 that it contains. Quartz is a common choice as a boat 24 material, as it can have smooth surfaces which promote easy removal of boron powder 12, it is typically easy to clean, and it has surface characteristics that can make any boron powder 12 remaining in the boat 24 after its intended removal readily visible to the casual observer. Several ceramic compounds are also common choices as a boat 24 material. The boat 24 can be shaped like a rectangular or square bowl, with a horizontal bottom and four vertical sides, although the boat can be constructed of various materials and have varied dimensions and shapes. Boats 24 can be used in batch furnaces or can be used in continuous furnaces, riding a conveyor as they pass through various heating zones. In one example, push rods can move the boats 24 through multiple heating zones of a tube oven.

The environment of the enclosed space is altered to create an oxygen-lessened or oxygen deficient atmosphere within the enclosed space that has less oxygen than ambient external atmosphere by volume number density of oxygen, by percentage of oxygen relative to other gases, or both volume number density and percentage relative to other gases. Such can also be presented as the environment of the enclosed space is altered to create an oxygen-lessened or oxygen deficient atmosphere within the enclosed space that has less oxygen than ambient atmosphere by one of volume number density of oxygen and by percentage of oxygen relative to other gasses. With regard to number density of oxygen, such is understood by the person of ordinary skill in the art as a quantity to describe of the degree of concentration of oxygen molecules in physical space (i.e., three-dimensional volume).

In one example, the processing system 10 can include a first port 26 for introducing a vacuum pressure from a pressure source 28 (schematically represented) into the furnace 16. Examples of a pressure source 28 include, but are not limited to a vacuum pump, negative pressure tanks, etc. Introduction of the vacuum pressure into the furnace 16 creates an oxygen-lessened or oxygen deficient atmosphere within the enclosed space. A vacuum pressure profile may include various multiple pressures over time in order to optimize the contaminant removal process. In one example, the vacuum pressure is substantially constant and is less than about 1.33×10⁻⁴ Pa (1.0×10⁻⁶ Torr). While an example vacuum pressure profile may be substantially constant, there can also be natural fluctuations of the vacuum pressure, such as a pressure drop when a boat 24 enters a hot heating zone of a tube oven, or a pressure rise as organic contaminants, in the form of at least one hydrocarbon compound, are vaporized.

The processing system 10 can further include a second port 30 for introducing at least one inert gas 32 (schematically represented by a bottle-type source example) into the furnace 16. Examples of an inert gas include, but are not limited to argon and nitrogen. Introduction of the inert gas 32 creates an oxygen-lessened/oxygen deficient atmosphere within the furnace 16 through displacement of oxygen.

A furnace heating cycle can begin after the boron powder 12 has been placed into the furnace 16 and an oxygen-lessened/oxygen deficient atmosphere has been created within the furnace 16. The furnace heating cycle subjects the boron powder 12 to an elevated temperature within the furnace 16 while the furnace 16 contains an oxygen-lessened/oxygen deficient atmosphere. Temperature profiles for the furnace heating cycle may ramp up to a particular temperature, hold constant for a time, and then ramp down. However, it is contemplated that the temperature profile may include multiple temperatures over time in order to optimize the heat application to the boron powder 12 and contaminant removal process. The elevated temperature vaporizes the organic contaminants, in the form of at least one hydrocarbon compound, so as to reduce an amount of the organic contaminant comingled with the boron powder 12. The elevated temperature can be selected to be high enough to vaporize organic contaminants, in the form of at least one hydrocarbon compound, within the boron powder, but not high enough to begin to densify or sinter the boron powder 12. In one example, the boron powder 12 is subjected to an elevated temperature between 350° C. and 600° C. More particularly, the elevated temperature can be about 500° C. This temperature promotes the vaporization of some organic contaminants. It is possible to know the boiling point of several organic contaminants, and it is possible to select an elevated temperature that is best suited to vaporize the particular organic contaminant(s) physically comingled with the boron powder 12. The length of time of application of the elevated temperature can be dependent upon factors including, but not limited to the quantity of boron being heated, the arrangement of the boron powder 12 on the boat 24, the size of the interior volume 18, etc.

Altering the environment of the enclosed space by introducing a vacuum pressure or introducing an inert gas 32 creates an oxygen-lessened/oxygen deficient atmosphere within the enclosed space. The lowered oxygen content of the enclosed space compared to ambient atmosphere tends to minimize the oxidation of the boron powder 12. Lower oxidation rates tend to eliminate boron coating defects in downstream manufacturing processes. In one example, oxygen-lessened/oxygen deficient atmosphere for the purposes of processing can be defined as less than 0.1 Pa partial pressure of oxygen. In one example in which a vacuum pressure is introduced, it is possible specify less than 1×10⁻⁵ Pa be utilized as providing an oxygen-lessened/oxygen deficient atmosphere. Still further it is possible to have a sufficiently oxygen-lessened/oxygen deficient condition based upon vacuum condition. For example, it is possible to have the desired oxygen-lessened/oxygen deficient condition when a high vacuum condition is achieved, with high vacuum being between 1×10⁻¹ to 1×10⁻⁷ Pa.

Another benefit to the introduction of a vacuum pressure to the enclosed space is a lower vapor pressure within the enclosed space. The lower vapor pressure promotes faster removal of organic contaminants (i.e., at least one hydrocarbon compound) from the boron powder 12 by lowering the boiling points of many compounds. Thus, the elevated temperature of the enclosed space can vaporize organic contaminants (i.e., at least one hydrocarbon compound) at lower temperatures due to the existence of the vacuum pressure within the enclosed space. This may be particularly useful in removing contaminants with high boiling points from the boron powder 12. Yet another benefit to the introduction of a vacuum pressure to the enclosed space is that a constantly applied vacuum pressure can remove gaseous vaporized organic contaminants (i.e., at least one hydrocarbon compound) from the enclosed space.

Another benefit to the introduction of an inert gas 32 to the enclosed space is the tendency of inert gases to promote convection action. Convection action within the interior volume 18 helps to speed the transfer of heat into the boron powder 12 and also helps to purge any vaporized compounds from the surface of the boron powder 12. Yet another benefit to the introduction of an inert gas 32 to the enclosed space can be a shortened cooling time period for the boron powder 12 prior to its removal from the interior volume 18.

The processing system 10 can also be used with a cooling cycle after vaporization of the contaminants from the boron powder 12. In order to decrease oxidation of the boron powder 12, the boron powder 12 can be cooled prior to removal from the oxygen-lessened/oxygen deficient environment within the interior volume 18. One example of a cooling cycle includes reduction of the boron powder 12 temperature to less than about 150° C. prior to removing the boron powder 12 from the interior volume 18. More particularly, the cooling cycle can include a reduction of the boron powder 12 temperature to less than about 100° C. prior to removing the boron powder 12. Various cooling profiles are contemplated for the cooling cycle.

Removal of the organic contaminants, in the form of at least one hydrocarbon compound, in the boron powder 12 via vaporization of organic contaminants enables production of a boron powder 12 with not more than about 0.1 weight percent of soluble residue. This level of impurity can be considered to be an acceptable level of soluble residue that does not affect a hydrophilic nature of the boron powder 12. One solvent that can be used to determine the amount of soluble residue within the boron powder 12 is methylene chloride via methods that are known in the art.

The method of removing organic contaminants, in the form of at least one hydrocarbon compound, from boron powder 12 using a furnace 16 to vaporize the organic contaminants and the associated process system is one solution to remove organic contaminants from a boron powder 12. Additionally, the use of a furnace 16 to remove the organic contaminants is a relatively simple alternative to other chemical wash methods of removing organic contaminants from boron powder 12.

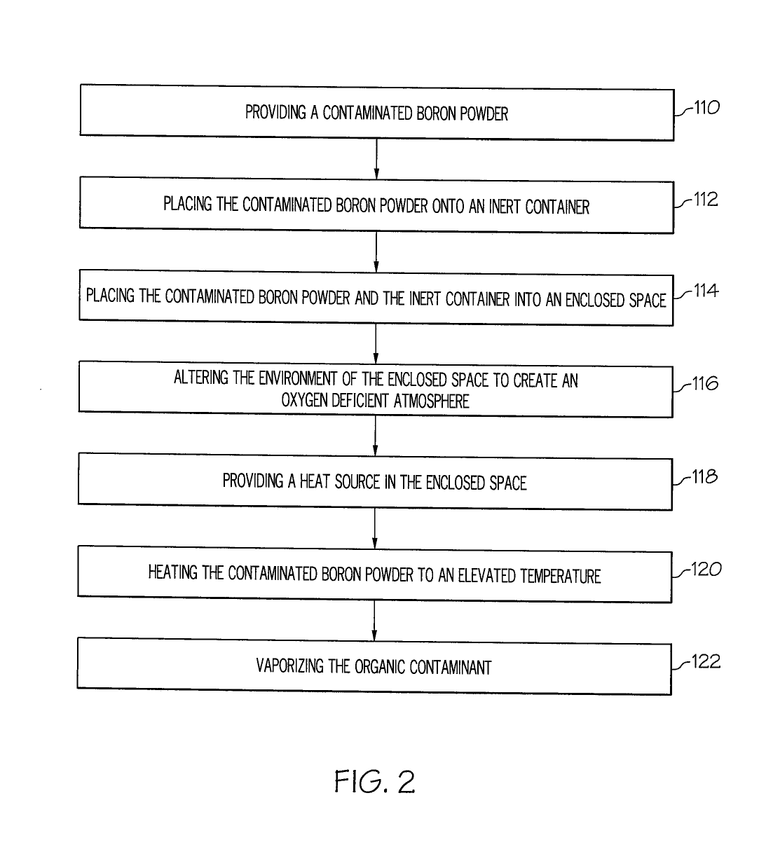

An example method of removing organic contaminants, in the form of at least one hydrocarbon compound, from boron powder 12 to meet purity requirements for downstream manufacturing applications is generally described in FIG. 2. The method can be performed in connection with the example furnace 16 shown in FIG. 1. The method includes the step 110 of providing a contaminated boron powder 12, the boron powder being physically intermixed (e.g., comingled) with at least one organic contaminant, in the form of at least one hydrocarbon compound. The organic contaminants can be introduced to the boron powder 12 during a jet milling operation from sources such as air compressor oils, adhesive materials, and particles of a polymeric liner material used on the interior of a jet mill.

The method also includes the step 112 of placing the contaminated boron powder 12 (i.e., boron powder and hydrocarbon compound physical intermixture) onto a boat 24, which is one example of an inert container used in processing furnaces 16. The boat 24 can be made of material that is resistant to the effects of high temperature, numerous heating and cooling cycles, and is not likely to impart contaminants to the boron powder 12 that it contains. Quartz and some ceramic compounds are common choices for boat 24 construction material.

The method further includes the step 114 of placing the inert container, the contaminated boron powder 12 into an enclosed space. The method also includes the step 116 of altering the environment of the enclosed space to create an oxygen-lessened/oxygen deficient atmosphere within the enclosed space. For example, the environment of the enclosed space can be altered by introducing a vacuum pressure or introducing a quantity of inert gas 32 into the enclosed space. Examples of an inert gas include nitrogen and argon.

The method includes the step 118 of providing a heat source 20 for the enclosed space. The heat source 20 can be any one or a combination of typical heat sources such as gas, electric heating element, infrared, microwave, etc. Examples of an enclosed space include, but are not limited to batch ovens, continuous ovens, cabinet ovens, tower ovens, tube ovens, sintering furnaces, etc.

The method also includes step 120 of heating the contaminated boron powder 12 (i.e., the physical intermixture) to an elevated temperature. The heat source 20 is activated and increases the temperature within the furnace 16. In one example, the heat source 20 subjects the boron powder 12 within the enclosed space to an elevated temperature of between 350° C. and 600° C. (one specific example of about 500° C.). The method also includes the step 122 of vaporizing the organic contaminant (i.e., the hydrocarbon compound) as a physical removal of the hydrocarbon compound from the boron powder at the elevated temperature and within the oxygen-lessened atmosphere so as to reduce the amount of organic contaminant physically comingled with the boron powder 12. The boron powder 12 can be cooled to less than about 150° C. (for example 100° C.) before it is removed from the oxygen-lessened/oxygen deficient environment. Various cooling profiles are contemplated for the cooling cycle.

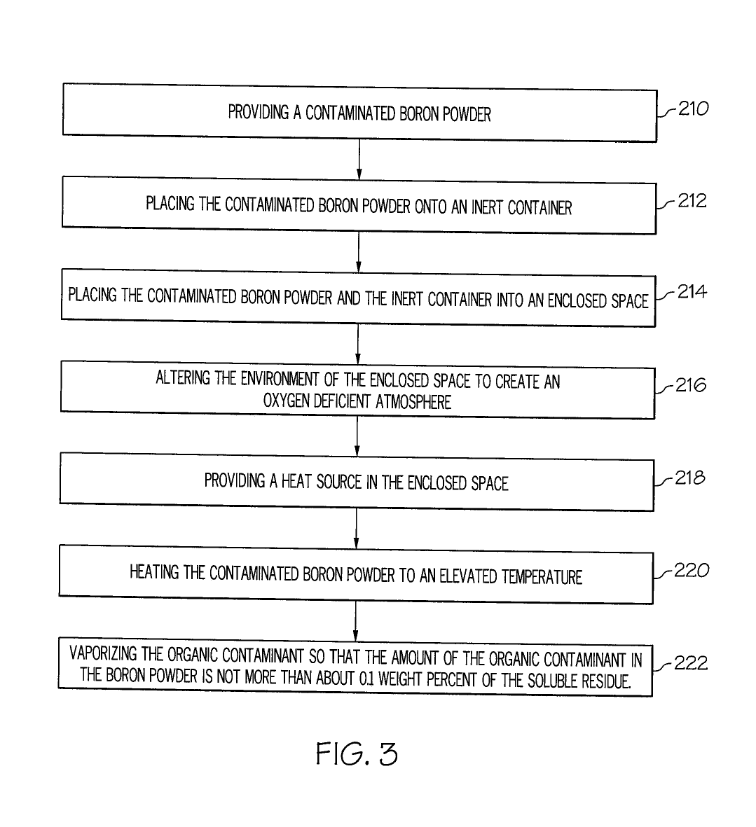

Another example method of removing organic contaminants (e.g., at least one hydrocarbon compound) from boron powder 12 to meet purity requirements for downstream manufacturing applications is generally described in FIG. 3. The method can be performed in connection with the example furnace 16 shown in FIG. 1. The method includes the step 210 of providing a contaminated boron powder 12, the boron powder being physical intermixed (i.e., comingled) with an organic contaminant (i.e., including at least one hydrocarbon compound). The organic contaminant can be introduced to the boron powder 12 during a jet milling operation from sources such as air compressor oils, adhesive materials, and particles of a polymeric liner material used on the interior of a jet mill.

The method also includes the step 212 of placing the contaminated boron powder 12 onto a boat 24, which is one example of an inert container used in processing furnaces 16. The boat 24 can be made of material that is resistant to the effects of high temperature, numerous heating and cooling cycles, and is not likely to impart contaminants to the boron powder 12 that it contains. Quartz and some ceramic compounds are common choices for boat 24 construction material.

The method further includes the step 214 of placing the contaminated boron powder 12 and the inert container into an enclosed space. The method also includes the step 216 of altering the environment of the enclosed space to create an oxygen-lessened/oxygen deficient atmosphere within the enclosed space. For example, the environment of the enclosed space can be altered by introducing a vacuum pressure or introducing a quantity of inert gas 32 into the enclosed space. Examples of an inert gas include nitrogen and argon.

The method includes the step 218 of providing a heat source 20 for the enclosed space. The heat source 20 can be any one or a combination of typical heat sources such as gas, electric heating element, infrared, microwave, etc. Examples of an enclosed space include, but are not limited to batch ovens, continuous ovens, cabinet ovens, tower ovens, sintering furnaces, etc.

The method also includes step 220 of heating the contaminated boron powder 12 to an elevated temperature. The heat source 20 is activated and increases the temperature within the furnace 16. In one example, the heat source 20 subjects the boron powder 12 within the enclosed space to an elevated temperature of between 350° C. and 600° C. (e.g., about 500° C.).

The method includes the step 222 of vaporizing at least some the hydrocarbon compound as a physical removal of the hydrocarbon compound from the boron powder at the elevated temperature and within the oxygen-lessened atmosphere such that the amount of the hydrocarbon compound physically intermixed with the boron powder is not more than about 0.1 weight percent of soluble residue.

The method can further include the step of cooling the boron powder 12 prior to removal of the boron powder 12 from the oxygen-lessened/oxygen deficient environment within the enclosed space. In order to decrease the potential oxidation of the boron powder 12, the boron powder 12 is kept within the oxygen-lessened/oxygen deficient environment during a cooling cycle. In one example, the oxygen-lessened/oxygen deficient environment can include argon or nitrogen which decreases the potential oxidation of the boron powder 12. The boron powder 12 can be cooled to less than about 150° C. (for example 100° C.) before it is removed from the oxygen-lessened/oxygen deficient environment. Various cooling profiles are contemplated for the cooling cycle.

It is to be appreciated that various additional aspects/steps can be provided to various methods in accordance with the present invention. The following are some possible additional aspects/steps. It is to be appreciated that these are only examples and are not an exhaustive list of additional aspects/steps. The step of providing a boron powder and hydrocarbon compound physical intermixture in the form of boron powder physically intermixed with the hydrocarbon compound can include providing the boron powder as chemically pure boron particles, with the hydrocarbon compound not being chemically integrated with the boron particles. The step of providing a boron powder and hydrocarbon compound physical intermixture in the form of boron powder physically intermixed with the hydrocarbon compound can include providing the boron powder as chemically pure boron particles, with the hydrocarbon compound not being chemically integrated with the boron particles. The step of vaporizing at least some the hydrocarbon compound as a physical removal of the hydrocarbon compound from the boron powder does not include use of a plasma. Such use of plasma might be better used for addressing oxides, which are chemical integrations. Use of plasma relies on the reactivity of the plasma to react away oxygen within an oxide via performance of a chemical reaction. The step of altering the environment of the enclosed space can include introducing a vacuum pressure to the enclosed space, and the vacuum pressure can be less than about 1.33×10⁻⁴ Pa (1.0×10⁻⁶ Torr). The step of altering the environment of the enclosed space can include introducing an inert gas to the enclosed space, and the inert gas can include at least one of nitrogen and argon.

In the described examples, the method and apparatus provide a means for cleaning boron powder 12 prior to making a boron powder coating solution by removing any oil films from the surface of the boron powder 12 particles. As can be appreciated, such is a physical intermixture of born and contaminate, and not a chemical integration of born and contaminate. The removal of organic contaminants in boron powder 12 via vaporization enables production of a boron powder 12 with not more than about 0.1 weight percent of soluble residue. This level of impurity can be considered to be an acceptable level of soluble residue that does not affect a hydrophilic nature of the boron powder 12. Additionally, the resulting boron powder 12 containing fewer or no organic contaminants reduces or eliminates downstream boron powder coating defects and improves the repeatability in the coating process. Thus, a boron powder 12 containing fewer or no organic contaminants can promote better coating properties for various applications, for example, boron coatings in neutron detectors. Boron powder 12 containing fewer or no organic contaminants can also help eliminate non-conforming finished products, for example, neutron detectors. It is to be noted that the process of the present invention is not a process to refine boron oxides into pure boron.

This written description uses examples to describe the disclosed subject matter, including the best mode, and also to enable any person skilled in the art to practice the claimed invention, including making and using any devices or systems and performing any incorporated methods. Other embodiments are within the scope and spirit of the disclosed subject matter.

What is claimed is:

1. A method of removing a hydrocarbon compound from boron powder for a boron powder and hydrocarbon compound physical intermixture, the method comprising:
providing a boron powder and hydrocarbon compound physical intermixture in the form of boron powder physically intermixed with the hydrocarbon compound;
placing the boron powder and hydrocarbon compound physical intermixture onto an inert container, with a material of the inert container being at least one of quartz and ceramic;
placing the inert container and the boron powder and hydrocarbon compound physical intermixture into an enclosed space;
altering the environment of the enclosed space to create an oxygen-lessened atmosphere within the enclosed space that has less oxygen than ambient atmosphere by one of volume number density of oxygen and by percentage of oxygen relative to other gasses;
providing a heat source for the enclosed space;
heating the boron powder and hydrocarbon compound physical intermixture within the oxygen-lessened atmosphere to an elevated temperature of between 350° C. and 600° C.; and
vaporizing at least some the hydrocarbon compound as a physical removal of the hydrocarbon compound from the boron powder at the elevated temperature and within the oxygen-lessened atmosphere.

2. The method according to claim 1, wherein the step of providing a boron powder and hydrocarbon compound physical intermixture in the form of boron powder physically intermixed with the hydrocarbon compound includes providing the boron powder as chemically pure boron particles, with the hydrocarbon compound not being chemically integrated with the boron particles.

3. The method according to claim 1, wherein the step of providing a boron powder and hydrocarbon compound physical intermixture in the form of boron powder physically intermixed with the hydrocarbon compound includes providing the boron powder without boron oxide.

4. The method according to claim 1, wherein the step of vaporizing at least some the hydrocarbon compound as a physical removal of the hydrocarbon compound from the boron powder does not include use of a plasma.

5. The method according to claim 1, wherein the step of altering the environment of the enclosed space includes introducing a vacuum pressure to the enclosed space.

6. The method according to claim 5, wherein the vacuum pressure is less than about 1.33×10⁻⁴ Pa (1.0×10⁻⁶ Torr).

7. The method according to claim 1, wherein the step of altering the environment of the enclosed space includes introducing an inert gas to the enclosed space.

8. The method according to claim 7, wherein the inert gas includes at least one of nitrogen and argon.

9. The method according to claim 1, wherein the amount of the hydrocarbon compound physically intermixed with the boron powder after completing the method of claim 1 is not more than about 0.1 weight percent of soluble residue.

10. The method according to claim 1, further comprising the step of cooling the boron powder to less than about 150° C. prior to removal of the boron powder from the enclosed space.

11. A method of removing a hydrocarbon compound from boron powder for a boron powder and hydrocarbon compound physical intermixture, the method comprising:
providing a boron powder and hydrocarbon compound physical intermixture in the form of boron powder physically intermixed with the hydrocarbon compound;
placing the boron powder and hydrocarbon compound physical intermixture onto an inert container, with a material of the inert container being at least one of quartz and ceramic;
placing the inert container and the boron powder and hydrocarbon compound physical intermixture into an enclosed space;
altering the environment of the enclosed space to create an oxygen-lessened atmosphere within the enclosed space that has less oxygen than ambient atmosphere by one of volume number density of oxygen and by percentage of oxygen relative to other gasses;
providing a heat source for the enclosed space;
heating the boron powder and hydrocarbon compound physical intermixture within the oxygen-lessened atmosphere to an elevated temperature of between 350° C. and 600° C.; and
vaporizing at least some the hydrocarbon compound as a physical removal of the hydrocarbon compound from the boron powder at the elevated temperature and within the oxygen-lessened atmosphere such that the amount of the hydrocarbon compound physically intermixed with the boron powder is not more than about 0.1 weight percent of soluble residue.

12. The method according to claim 11, wherein the step of providing a boron powder and hydrocarbon compound physical intermixture in the form of boron powder physically intermixed with the hydrocarbon compound includes providing the boron powder as chemically pure boron particles, with the hydrocarbon compound not being chemically integrated with the boron particles.

13. The method according to claim 11, wherein the step of providing a boron powder and hydrocarbon compound physical intermixture in the form of boron powder physically intermixed with the hydrocarbon compound includes providing the boron powder without boron oxide.

14. The method according to claim 11, wherein the step of vaporizing at least some the hydrocarbon compound as a physical removal of the hydrocarbon compound from the boron powder does not include use of a plasma.

15. The method according to claim 11, wherein the step of altering the environment of the enclosed space includes introducing a vacuum pressure to the enclosed space.

16. The method according to claim 15, wherein the vacuum pressure is less than about 1.33×10⁻⁴ Pa (1.0×10⁻⁶ Torr).

17. The method according to claim 11, wherein the step of altering the environment of the enclosed space includes introducing an inert gas to the enclosed space.

18. The method according to claim 17, wherein the inert gas includes at least one of nitrogen and argon.

19. The method according to claim 11, further comprising the step of cooling the boron powder to less than about 150° C. prior to removal of the boron powder from the enclosed space.
